(19) United States
(12) Patent Application Publication
(10) Pub. No.: US 2004/0101268 A1
(43) Pub. Date: May 27, 2004

(54) Optical device structures based on photo-definable polymerizable composites

(75) Inventors: Min-Yi Shih, Niskayuna, NY (US); Thomas Bert Gorczyca, Schenectady, NY (US)

Correspondence Address: General Electric Company, CRD Patent Docket Rm 4A59, P.O. Box 8, Bldg. K-1, Schenectady, NY, 12301, US

(73) Assignee: General Electric Company

(21) Appl. No.: 10/306,440

(22) Filed: Nov. 27, 2002

(51) Int. Cl. G02B 6/10

(52) U.S. Cl. 385/141; 385/129

(57) ABSTRACT

An optical device structure comprising a substrate and at least one topological feature. The topological feature comprises a polymeric composite material formed from a polymerizable binder and an uncured monomer. The topological feature has a controlled topological profile and a controlled refractive index across the topological feature. The optical device structure may be a multimode waveguide device, a single mode waveguide device, an optical data storage device, thermo-optic switches, or microelectronic mechanical system.

### BACKGROUND OF INVENTION

The invention relates to optical device structures comprising a polymeric composite material. More particularly, the present invention relates to a topological feature comprising an optical device structure. The invention can be used to form an optical device structure comprising a clad and a core layer.

Modern high-speed communications systems are increasingly using optical fibers for transmitting and receiving high-bandwidth data. The excellent properties of polymer optical fiber with respect to flexibility, ease of handling and installation are an important driving force for their implementation in high bandwidth, short-haul data transmission applications such as fiber to the home, local area networks and automotive information, diagnostic, and entertainment systems.

In any type of optical communication system there is the need for interconnecting different discrete components. These components may include devices, such as lasers, detectors, fibers modulators, and switches. Polymer-based devices, such as waveguides, can offer a viable way of interconnecting these components, and offer a potentially inexpensive interconnection scheme. Such devices should be able to couple light vertically into or out of the waveguide with good efficiency and low propagation losses, which in turn are determined primarily by the quality of both the polymer and the device boundary.

A proper selection of polymeric materials is necessary for making polymeric optical waveguides that display a low attenuation and improved thermal stability without an excessive increase in scattering loss. Moreover, a well-defined introduction of light-focusing or light-scattering elements is potentially useful to obtain controlled emission of light in polymeric optical waveguides.

A requirement for making opto-electronic multi-chip modules is to provide an optical interconnect between the electronic circuitry and the “optical bench” portion of the package. One method to do this is to have a vertical cavity surface emitting laser (hereinafter also referred to as “VCSEL”), which is integrated with and controlled by the electronic portion of the module, direct its laser light vertically into the base of the optical portion of the module. An approximate 45-degree angle “mirror” is required to change the direction of the laser light from a vertical to a horizontal direction, thus directing it into the optical bench. This mirror is difficult to fabricate with conventional methods for several reasons. The mirror should have a surface inclined 45 degrees with respect to the horizontal surface of the VCSEL. When the mirror is positioned over a VCSEL, it reflects a vertical light beam projected from the VCSEL to a horizontal direction into a polymer waveguide comprising the optical bench. Furthermore, the mirror surface must be very smooth to limit losses in light transmission, and it must be precisely aligned to the underlying VCSEL. Another problem encountered with planar polymer waveguides is the necessity to have smooth edges on the waveguide structures to limit light transmission losses. It is believed that the use of conventional reactive ion etching techniques to define waveguide structures will generate edges which will be too rough to use with single mode light transmission. Previously, 45-degree angle mirrors were defined either by laser ablation of the core polymer material at an appropriate angle, reactive ion etching using a gray scale mask, or by embossing the required structure onto the polymer surface. Waveguide structures can be formed by several techniques including coating a lower cladding layer on a suitable substrate and forming a trench in the clad layer by embossing, etching or development, and filling the trench with a core material, and over-coating with a top clad layer. Ridge waveguides can be formed by coating a lower clad and core layer onto a substrate, patterning the core by etching or development to form a ridge, and over-coating with an upper clad layer. Planar waveguides can be formed by coating a lower clad and core material over a substrate, defining the waveguide by UV exposure and depositing an upper clad layer over it. Reactant diffusion occurs between the unexposed core and surrounding clad layers into the exposed core area changing its refractive index (hereinafter also referred to as “RI”) to form the waveguide.

There continues to be a need for optical devices comprising low loss radiation curable materials, with control of at least one of topography, refractive index, or composition by a more direct process having fewer manufacturing steps. Furthermore, it would be desirable to develop a process that will enable the formation of optical device structures, such as waveguide structures with smooth, tapered edges to allow vertical interconnection with other optical devices or laser devices, without use of reactive ion etching or development, by using a single polymerizable composite as the raw material.

### SUMMARY OF INVENTION

Accordingly, one aspect of the invention is to provide an optical device structure comprising a substrate having a composition and a refractive index, and at least one topological feature. The topological feature is disposed on a surface of the substrate, and comprises a polymeric composite material. The topological feature has a controlled topological profile and a controlled refractive index across the topological feature, wherein the topological feature redirects radiation passing therethrough.

A second aspect of the invention is to provide a topological feature comprising an optical device structure, wherein the topological feature is disposed on a substrate. The topological feature comprises a polymeric composite material having a controlled composition, a controlled topological profile, and a controlled refractive index across the topological profile, wherein the topological feature redirects radiation passing therethrough.

A third aspect of the invention is to provide an optical device structure comprising a substrate, and at least one topological feature disposed on a surface of the substrate. The topological feature is formed from a polymerizable composite comprising at least one polymer binder and at least one uncured monomer and has a controlled composition profile. The topological feature has a controlled refractive index that is different from a refractive index of the substrate, wherein the topological feature redirects radiation passing therethrough.

### BRIEF DESCRIPTION OF DRAWINGS

FIG. 1 is a schematic representation showing the curing of a polymerizable composite comprising a polymeric binder and a UV-polymerizable monomer;

FIG. 2 is a schematic representation showing the creation of a surface topography after a post UV-cure evaporation of monomer;

FIG. 3 is a schematic diagram illustrating creation of a surface topography array by UV irradiation of a polymerizable composite material through a gray scale mask;

FIG. 4 is a plot showing refractive index contrast between a UV-exposed and UV-unexposed polymer/epoxy thin film deposited on a silicon wafer;

FIG. 5 is a schematic plot showing the dependence of composite refractive index of a material comprising an optical device structure on the quantity and refractive index of cured components;

FIG. 6 is a schematic diagram showing the creation of a photo-patterned layer topography from a polymerizable composite;

FIG. 7 is a schematic diagram showing the creation of a photo-patterned stacked layer topography from a polymerizable composite;

FIG. 8 is a schematic diagram illustrating creation of a VCSEL-integrated micro-lens array;

FIG. 9 is a scanning electron micrograph showing a plurality of about 5-micron-sized dome-shaped structures formed from a post-irradiation post-bake step of a 60:40 mixture by weight of poly(methyl methacrylate) and CY 179;

FIG. 10 is a scanning electron micrograph showing a plurality of about 24-micron-sized dome-shaped structures formed from a post-irradiation post-bake step of a 60:40 mixture by weight of poly(methyl methacrylate) and CY 179;

FIG. 11 is a scanning electron micrograph showing approximately 5-micron-sized dimple-shaped structures formed from a post-irradiation post-bake step of a 60:40 mixture by weight of poly(methyl methacrylate) and CY 179;

FIG. 12 is a schematic diagram illustrating creation of a VCSEL-integrated micro beam-shaping lens array;

FIG. 13 is a plot showing the input intensity profile of a laser source of a VCSEL;

FIG. 14 is a plot showing the output intensity profile of a laser source of a VCSEL; and

FIG. 15 is a scanning electron micrograph showing approximately 24-micron-sized “domes” formed after UV exposure and curing of a 60:40 mixture by weight of poly(methyl methacrylate) and CY 179.

### DETAILED DESCRIPTION

In the following description, like reference characters designate like or corresponding parts throughout the figures. It is also understood that terms such as “top”, “bottom”, “outward”, inward”, and the like are words of convenience and are not to be construed as limiting terms.

It should be understood that the figures and drawings in general are for the purpose of describing a preferred embodiment of the invention and are not intended to limit the invention thereto.

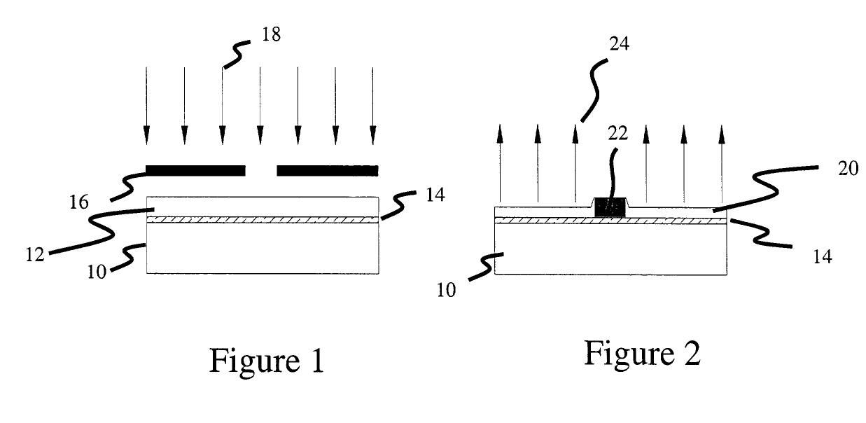

FIG. 1 is a schematic representation showing the curing of a polymerizable composite comprising a polymeric binder and a radiation-polymerizable monomer. A layer of polymerizable composite 12 is deposited on a surface 14 of a substrate 10. The polymerizable composite comprises a polymer binder and an uncured monomer. The patterning of polymerizable composite 12 is carried out using a mask 16 so as to define an area that can be exposed to curing radiation 18. Ultraviolet (UV) radiation is preferably used as the curing radiation. During the curing step, the monomer polymerizes in the areas exposed to the curing radiation. In addition to UV radiation, other forms of irradiation, such as, but not limited to, a direct-write laser can also be used. Although the curing radiation is referred to herein as UV radiation, it is understood that other radiation sources may be used to cure the polymerizable composite as well. The method of forming an optical device structure of the present invention is described in U.S. patent application Ser. No. ______, entitled “Method for Making Optical Device Structures,” by Thomas B. Gorczyca, filed ______, the contents of which are incorporated herein by reference in their entirety.

FIG. 2 is a schematic diagram showing the baking 24 (hereinafter also referred to as “volatilizing”) of uncured monomer from an area of the polymerizable composite 12 that is not exposed to the radiation. In addition, any uncured monomer remaining in the exposed portions, or areas, is volatized as well. This process results in evaporation of the volatile uncured monomer component from the unexposed areas, thereby resulting in creation of an optical device structure 22 having a surface 20. The surface 20 of the optical device structure has at least one topological feature. The at least one topological feature has a dimension of less than about 100 microns in one embodiment, less than about 5 microns in another embodiment, and less than about 2 microns in yet another embodiment. Furthermore, the topological feature of the optical device structure 22 has a controlled topological profile in one embodiment, and a controlled composition in another embodiment. Depending upon the nature of the polymerizable composite 12, and the conditions used for the subsequent patterning and baking steps, it is possible to obtain a variety of topological profiles, therefore leading to a variety of optical device structures. In one embodiment, the topological profile includes at least one step. The step may be either an upward or a downward step. In another embodiment, the topological profile includes at least one of a convex profile, a concave profile, or a polygonal profile. Generally, the topological profile is such that the step forms an angle from about 5 degrees to about 90 degrees with respect to the surface of the substrate 14.

A proper choice of materials to form the polymerizable composite 12 makes it possible to achieve large differences in refractive indices, thereby enabling very small bending radii for the light beam passing through the formed optical device structure 22. The refractive index can also vary in a controlled fashion across the topological feature. For example, it can vary linearly across the topological feature. The refractive index can also vary in a controlled way such that it lies between a maximum value and a minimum value. The refractive index varies across the topological feature by at least about 0.2% in one embodiment, and by up to about 20% in another embodiment, and by about 5% in another embodiment. In another embodiment, the controlled refractive index has a maximum value or a minimum value at the center of the topological feature.

In addition to surface topography, the optical device structures resulting from the volatilizing 24 can also result in a compositional change. Among other factors, the compositional change is the combined result obtained from the polymerization of the monomer in the radiation-exposed areas, concomitant migration of monomer from the unexposed areas to the radiation-exposed areas during the irradiation step, and the volatilizing of uncured monomer, primarily from the areas unexposed to the radiation. In one embodiment, the topological feature has a controlled composition. For example, the radiation-induced polymerization of the monomer can be carried out such that only a portion of the polymerizable monomer is polymerized. The remaining monomer is volatilized in the succeeding bake step. This process of incomplete polymerization can lead to optical devices having topographies, compositional changes, and properties that are different from those where all of the monomer in the exposed area is polymerized. In many embodiments, the composition change creates a change in at least one of coefficient of thermal expansion, glass transition temperature, refractive index, birefringence, light transmission, modulus, dielectric properties, and thermal conductivity of the optical device structure.

The polymerizable composite 12 comprises a polymer binder and an uncured monomer. The polymer binder comprises any polymer that is thermally stable during the monomer evaporation step. The polymer binder should also be compatible with the monomer chosen. In an embodiment, the polymer binder comprises at least one of an acrylate polymer, a polyetherimide, a polyimide, a siloxane-containing polyetherimide, a polycarbonate, a siloxane-containing polycarbonate, a polysulfone, a siloxane-containing polysulfone, a polyphenylene oxide, a polyether ketone, a polyvinyl fluoride, and combinations thereof. In a particular embodiment, the acrylate polymer comprises at least one of poly(methyl methacrylate), poly(tetrafluoropropyl methacrylate), poly(2,2,2-triflouroethyl methacrylate), copolymers comprising structural units derived from acrylate polymers, and combinations thereof. In another embodiment, the polyimide comprises the building blocks, 2,2′-bis[4-(3,4-dicarboxyphenoxy)phenyl]propane dianhydride, 1,3-phenylenediamine, benzophenonetetracarboxylic acid dianhydride and 5(6)-amino-1-(4′-aminophenyl)-1,3-trimethylindane.

The uncured monomer comprises any monomer that is compatible with the polymer binder, can be polymerized by exposure to radiation, and will evaporate in the monomer form during the bake step. The monomer can be mono-functional; that is, it forms a thermoplastic polymer during irradiation. Alternatively, the monomer can be poly-functional; that is, it forms a thermosetting polymer matrix when irradiated. The monomers may react with both themselves and the polymer binder during irradiation. The uncured monomer is at least one of an acrylic monomer, a cyanate monomer, a vinyl monomer, an epoxide-containing monomer, and combinations thereof. Non-limiting examples of monomers include acrylic monomers, such as methyl methacrylate, 2,2,2-trifluoroethyl methacrylate, tetrafluoropropyl methacrylate, benzyl methacrylate, and glycol-based and bisphenol-based diacrylates and dimethacrylates; epoxy resins, such as, but not limited to: aliphatic epoxies; cycloaliphatic epoxies, such as CY-179; bisphenol-based epoxies, such as bisphenol A diglycidyl ether and bisphenol F diglycidyl ether; hydrogenated bisphenol-based and novolak-based epoxies; cyanate esters; styrene; allyl diglycol carbonate; and others.

The monomer may be polymerized by exposure to radiation. In one embodiment, ultraviolet (sometimes referred throughout the description as “UV”) radiation is preferably used as the curing radiation. Besides UV radiation, other forms of radiation, such as a direct-write laser, can also be used to polymerize the monomer.

The use of either alternative polymerizable monomers or polymer binders is limited only by their compatibility with the cured and/or baked materials of the invention.

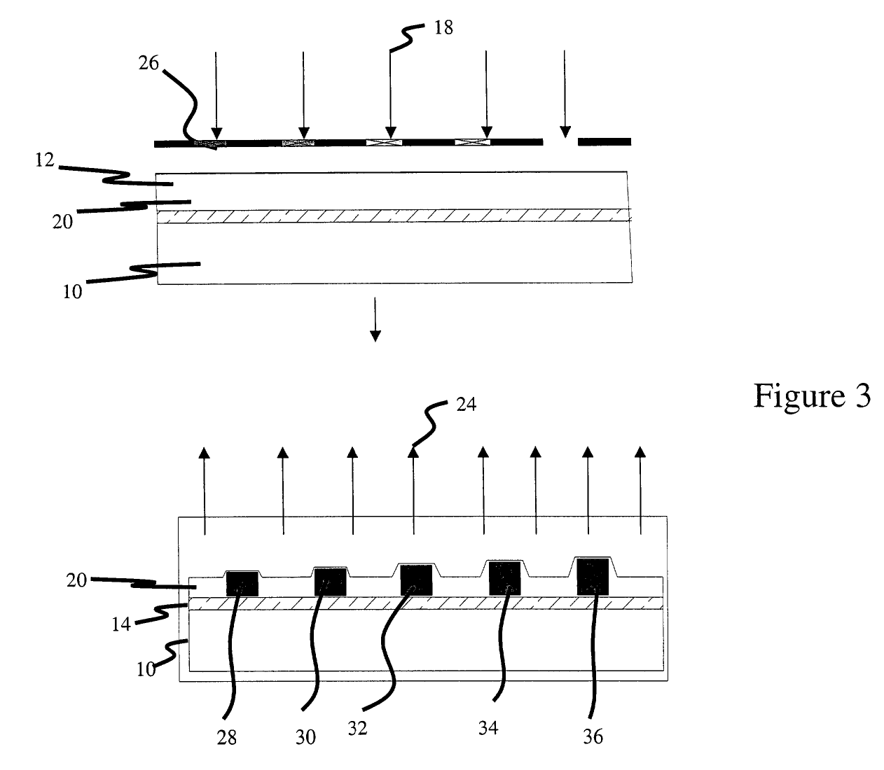

The mask used for defining the area to be exposed to the radiation source can have various shapes, sizes, and different degrees of grayscale. Different grayscales will produce regions of different compositions. The use of a grayscale mask may thus be used to produce different topographies or an array of topographies in a single exposure of a single layer of a polymerizable composite. FIG. 3 is a schematic diagram illustrating creation of optical devices 28-36 having an array of topological features by UV irradiation 18 of a polymerizable composite 12 through a gray scale mask 26. After volatilizing the uncured monomer, the process affords an optical device structure array. In one embodiment, the optical device structure comprises a plurality of device structures having at least one topological feature. In another embodiment, an optical device structure may include a plurality of topological features that forms an array.

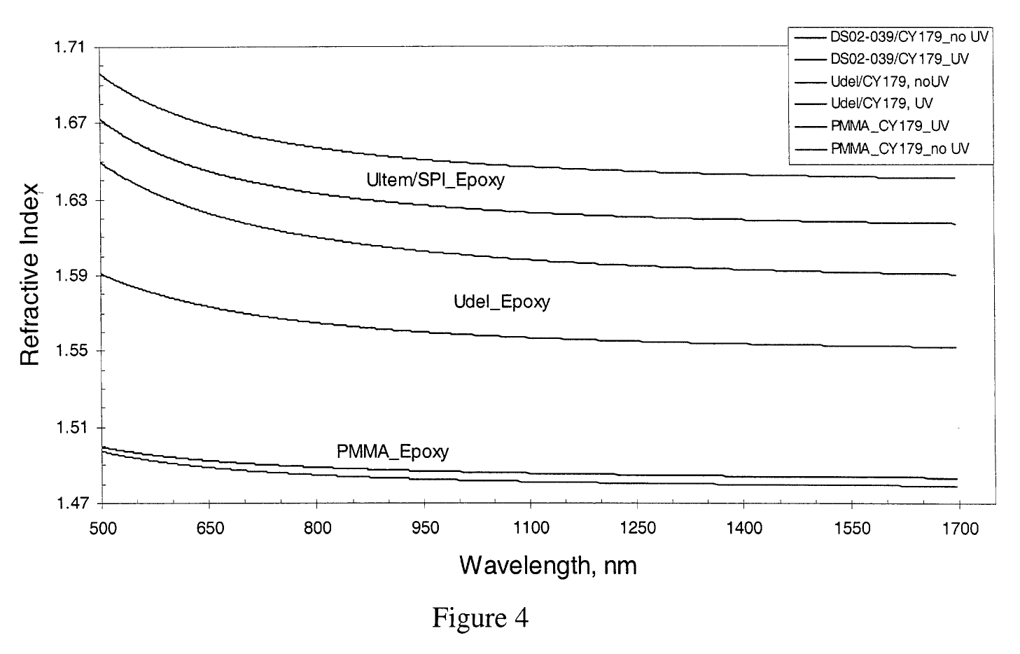

Radiation curing of the monomer in the polymerizable composite results in a cured material having a refractive index that is different than that of the polymerizable composite that is shielded by the mask from the radiation. Depending on the composition of the polymerizable composite, the radiation-cured portion may have a refractive index that is either greater than or less than the portion shielded by the mask. FIG. 4 is a plot showing refractive index contrast between a UV-exposed and unexposed polymer/epoxy thin films deposited on a silicon wafer. A wide range of refractive index differences can be achieved by choosing the appropriate polymer binder and uncured monomer component. The index of refraction is defined as the speed of light in a vacuum divided by the speed of light in a medium. The difference in refractive index between different materials provides a measurement of the amount a propagating light wave will refract or bend upon passing from one material to another where the propagation velocity is different. In one embodiment, the refractive index gradient between core (i.e., a first region) and clad is at least 0.2%. In many of the optical device structures described herein, the RI gradient between clad and core (i.e., a second region) is about 5%. For fully polymeric systems, in which both the clad and core comprise fully polymerized material, a difference in RI between core and clad of up to about 20% difference may be achieved. For example, an optical device structure comprising a core having an RI of about 1.59 and a clad having an RI of about 1.55 would have a smooth RI gradient of about 2.6% across a transition width from about 0.5 microns to about 3 microns. Thin film, planar, gradient refractive index structures can be fabricated by controlling UV dose, amount of evaporation and initial starting materials. A gradient RI waveguide is preferable over a step RI waveguide because it provides a lower loss light transmission.

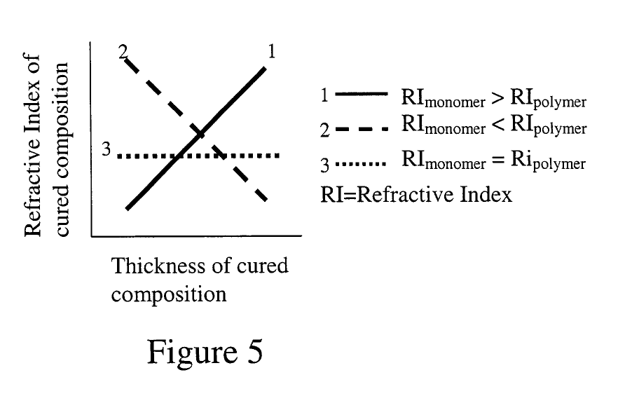

FIG. 5 is a schematic plot showing the dependence of composite refractive index of materials that may be used to form an optical device structure on the quantity and refractive index of cured components. Composite refractive index (hereinafter designated as “RI_{composite}”) depends on the quantities of the individual polymer components making up the composite polymer and their respective refractive indices, as shown in Equation (1):

RI_{composite}=Σ(Wₙ×RIₙ) (Eq. 1)

where “Wₙ ” represents the weight percent of the n^{th} polymer component in the composite polymer, and “RIₙ” represents the refractive index of the n^{th} polymer component in the composite polymer. FIG. 5 shows that when the refractive index of the monomer (hereinafter designated as “RIₘₒₙₒₘₑᵣ”) is greater than the refractive index of the polymer binder (hereinafter designated as “RI_{polymer}”) resulting from the irradiation and bake steps, the refractive index of the polymer composite increases with increasing thickness of the polymer composite. On the other hand, when RIₘₒₙₒₘₑᵣ is lower than RI_{polymer}, the refractive index of the polymer composite decreases with increasing thickness of the polymer composite. When RIₘₒₙₒₘₑᵣ and RI_{polymer} are approximately equal, the refractive index of the polymer composite remains relatively unchanged with thickness. Thus, the preparation and composition of the polymerizable composite can be tailored to meet the refractive index requirements of a particular optical device structure.

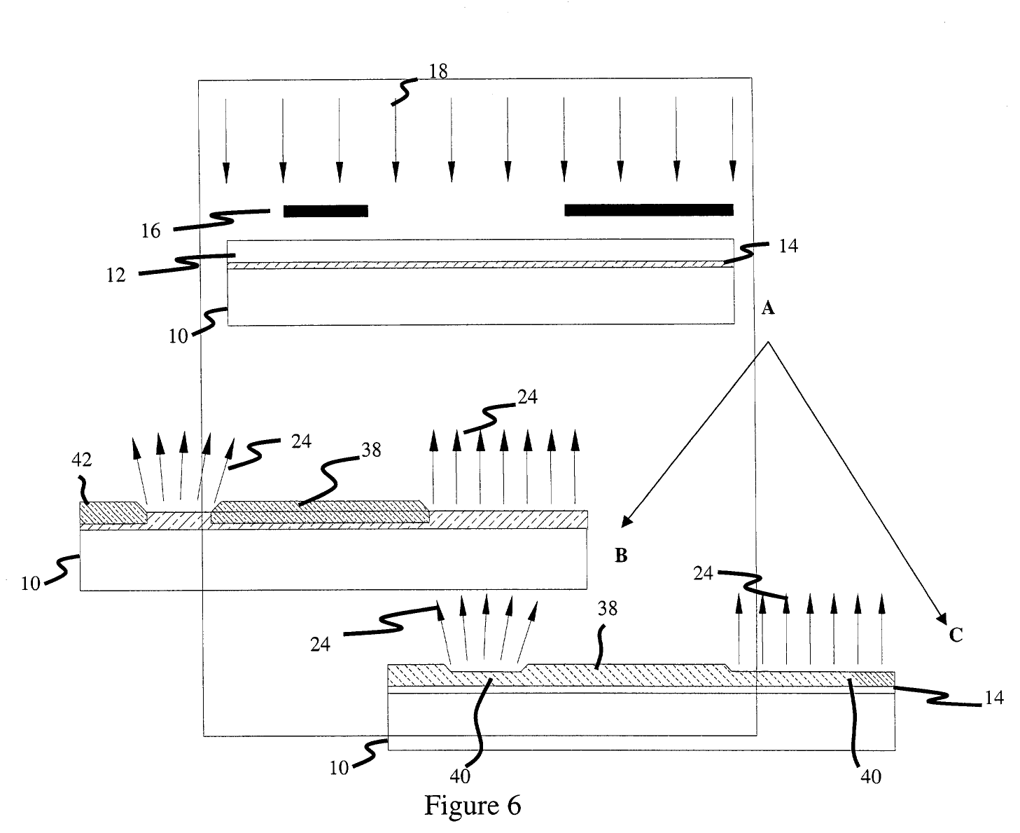

FIG. 6 is a schematic diagram showing the creation of a photo-patterned layer topography formed from a polymerizable composite. In this figure, A is transformed into B, or A is transformed into C, depending on the relative magnitudes of the refractive indices of the monomer and the polymer binder in the polymerizable composite. Thus, B is the outcome if, in A, the RIₘₒₙₒₘₑᵣ is greater than RI_{polymer}, whereas C is the outcome if, in A, RIₘₒₙₒₘₑᵣ is about equal to RI_{polymer}.

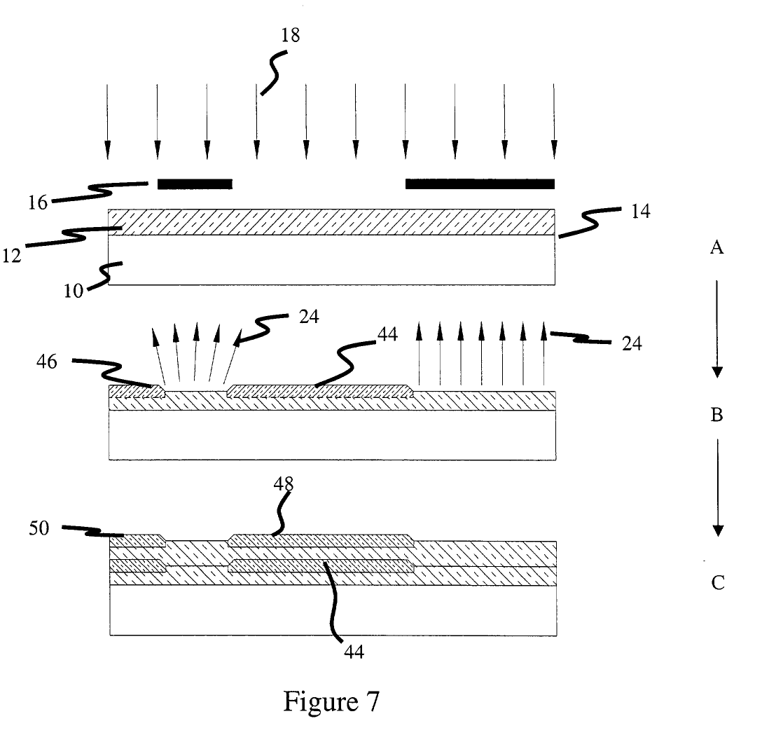

The process of forming an optical device structure, as described previously, can also be repeated to produce integral vertically stacked optical device structures. FIG. 7 is a schematic diagram showing the creation of a photo-patterned stacked layer topography definition from a polymerizable composite. Thus, in one embodiment, the volatilization 24 can be followed by providing a second polymerizable composite to previous optical device structures 44 and 46, depositing a second layer of the second polymerizable composite on the optical device structure, obtained as previously described, patterning the second layer to define an exposed area and an unexposed area of the second layer, irradiating the exposed area of second layer, and volatilizing the second uncured monomer to form new optical device structures 48 and 50. The second polymer composite comprises a second polymer binder and a second uncured monomer. The method described hereinabove can be used with a second polymerizable composite whose composition is either the same or different from the composition of the first polymerizable composite used to form the first optical device structure. Generally, to form waveguides with edge taper for vertical connection with a VCSEL, the curable monomer comprising the polymerizable composite should ideally have a refractive index that is greater than that of the polymeric material formed by the radiation-induced curing step and the subsequent bake step.

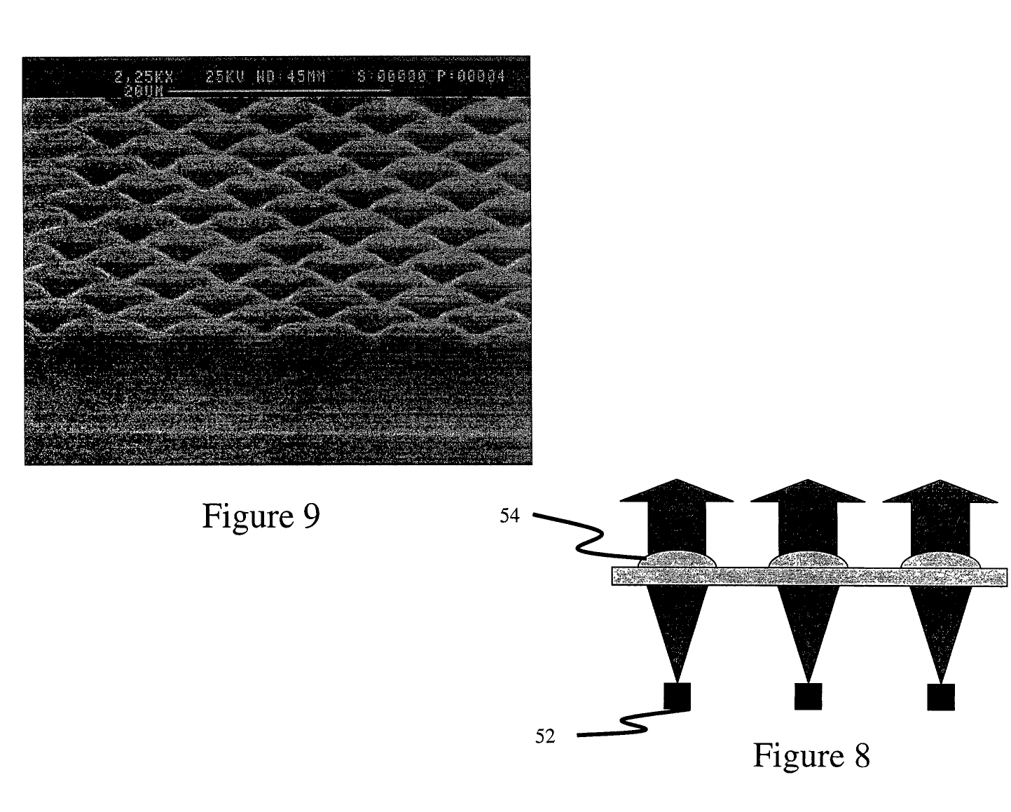

The aforementioned approaches to building optical device structures can have many potential applications in fabrication of miniature optical device structures. FIG. 8 is a schematic diagram illustrating creation of a VCSEL-integrated micro-lens array. The dome shaped structures 54, formed by the method of the invention, can act as a beam-focusing micro-lens array. By a proper choice of a radiation-polymerizable monomer, polymer binder, and masking conditions, an array of identical optical device structures, or optical device structures having a range of thicknesses and refractive indices can be created, each of which can be integrated with a VCSEL 52, as shown in FIG. 8.

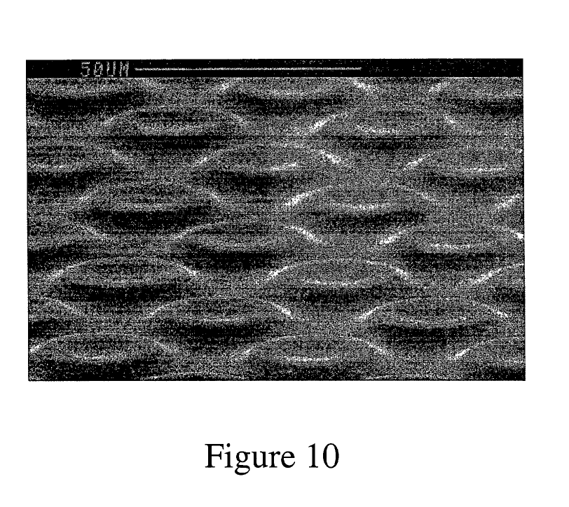

FIG. 9 is a scanning electron micrograph showing a plurality of about 5-micron dome-shaped structures formed from a post-irradiation post-bake step of a 60:40 mixture by weight of poly(methyl methacrylate) and CY 179. By using the method described above, and a larger sized mask, larger dome-shaped optical device structures can also be created. The dome-shaped structures formed as shown in FIG. 9 may also include dimple-structures located at approximately the center of each dome-shaped structure. Each dimple-shaped structure shown in FIG. 9 has a diameter of about 5 microns. FIG. 10 is a scanning electron micrograph showing a plurality of dome-shaped structures, each having a diameter of about 24 microns, that were formed from a post-irradiation post-bake step of a 60:40 mixture by weight of poly(methyl methacrylate) and CY 179.

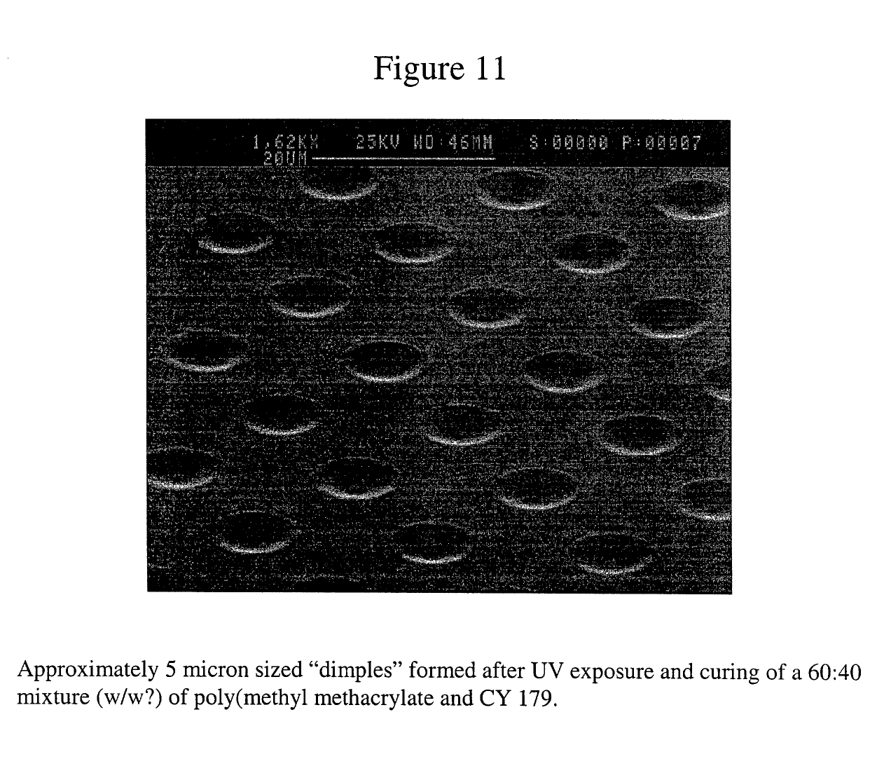

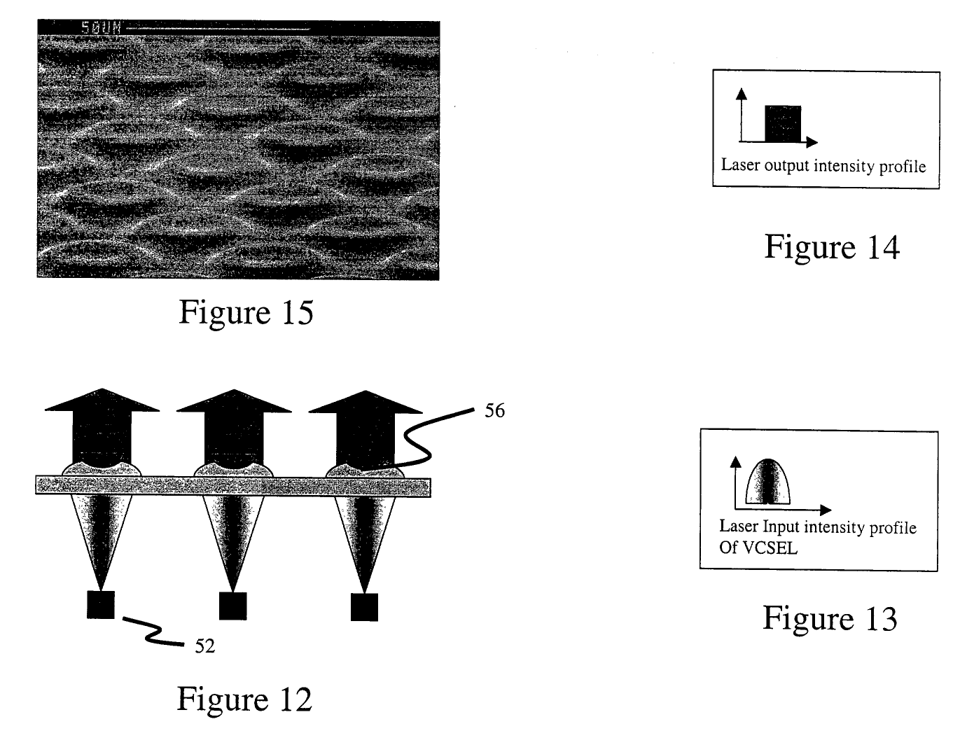

FIG. 11 is a scanning electron micrograph showing dimple-shaped structures formed from a post-irradiation post-bake step of a 60:40 mixture by weight of poly(methyl methacrylate) and CY 179. These dimple-shaped structures have the potential to function as beam shaping lenses when integrated with a VCSEL. FIG. 12 is a schematic diagram illustrating creation of a VCSEL-integrated micro beam-shaping lens array. A divergent laser beam from the VCSEL 52 passing through the convex surface 56 of the dimple can emerge as a focused parallel beam. FIG. 13 is a plot showing the input intensity profile of the VCSEL laser source across the convex surface of the dimple-shaped optical device structure. FIG. 14 is a plot showing the output intensity profile of the VCSEL laser source across the concave surface of the dimple-shaped optical device structure. It can be seen that the wavelength spread of the beam after passing through the dimple-shaped topography is narrower than that produced by the VCSEL 52. The formation of such dimple-shaped structures is illustrated in FIG. 15, which is a scanning electron micrograph showing domes, each having a diameter of approximately 24-microns, formed after UV exposure and curing of a 60:40 mixture by weight of poly(methyl methacrylate) and CY 179.

The substrate 10 may be any material on which it is desired to establish an optical device structure. The substrate material may, for example, comprise a glass, quartz, plastic, ceramic, a crystalline material, and semiconductor materials, such as, but not limited to, silicon, silicon oxide, gallium arsenide, and silicon nitride. In one embodiment, the substrate is any type of a flexible material. In another embodiment, the flexible substrate comprises a plastic material. The substrate can also be a silicon wafer, which is known to have high surface quality and excellent heat sink properties. In another embodiment, the substrate comprises a clad layer comprising an optical device structure.

The methods described above can be used to produce optical device structures, such as a waveguide, a multiplexer, a mirror, a lens, and lens components. The process enables the formation of waveguide structures with controlled refractive index and smooth, tapered edges to allow vertical interconnection between the electronic portion of the electro-optic modules and the optical bench portion, or vertical connection between the fiber optic cables and the optical bench. Furthermore, the optical device structures and the optical device structures described hereinabove can be formed without use of reactive ion etching or development, thus making the process more environmentally friendly. The tapered edges can be used as a mirror to direct VCSEL or optical fiber emission into the horizontal optical bench. The polymeric composite material having the refractive index gradient will define the waveguide path. In specific embodiments, the optical device structure comprises at least one of a waveguide, a 45-degree mirror, and combinations thereof. In another embodiment, the optical device structure comprises at least one of a multimode waveguide device, a single mode waveguide device, an optical data storage device, a thermo-optic switch, and a microelectronic mechanical system.

Another aspect of the invention is to provide a topological feature for use in an optical device structure. The topological feature is disposed on a substrate and comprises a polymeric composite material having a controlled composition and a controlled topological profile. Furthermore, the topological feature has a controlled refractive index across the topological profile. This can lead to device structures having a range of tailor-made topological features, which is vital for forming optical device structures having more complex architectures. One aspect of the method used to form the topological feature is that it includes radiation-induced polymerization of the monomer such that only a portion of the polymerizable monomer present in the polymerizable composite is polymerized, with volatilization of the remaining monomer occurring in the succeeding bake step. This process of incomplete polymerization can lead to optical device structures having surface topographies, topographic profiles, compositional changes, and properties that are different from those optical device structures that are formed by methods in which all of the monomer in the area exposed to radiation is polymerized. An example of a property that can change is refractive index. In one embodiment, the controlled refractive index across the topological profile is different from the refractive index of the substrate. In another embodiment, the composition of the topological feature can be different from that of the substrate upon which the topological feature comprising the optical device structure is created. All of the other embodiments previously described for the optical device structure disclosed herein apply to the topological feature comprising the optical device structure.

### EXAMPLE 1

This Example describes the preparation of a surface topography comprising a polymeric composite material derived from Apec™ 9371 polycarbonate (available from Bayer Company) and CY 179 using UV-irradiation.

A mixture was prepared containing approximately 50 parts by weight Apec™ polycarbonate, approximately 50 parts by weight of CY 179, 1 part by weight of Cyracure UVI-6976 photo catalyst, 150 parts by weight anisole and 50 parts by weight cyclopentanone. A 50 micron thick film was prepared on a glass substrate by spin coating the material and partially curing it for 20 minutes at 90° C. to remove the solvent. A patterned chrome image on a quartz plate was used to expose and define a pattern on the polycarbonate/epoxy film. A 30 second exposure using a Karl Suss contact printer was used. After exposure, the sample was baked on a hotplate for 1 hour at 200° C. Surface profilometry measurements of the resulting surface topography indicated approximately a 23 micron step between the lower unexposed film surface and the upper exposed film surface. Weight loss measurements on other test samples receiving either blanket UV exposure or no exposure and bake indicated about 90% epoxy loss from unexposed areas, whereas exposed areas lost less than 10% epoxy.

The results from Example 1 indicate that after the bake step, the composition of the UV-exposed and the unexposed areas differ significantly from each other. In the UV-exposed areas, the composite polymeric material showed a composition corresponding to approximately 50 weight percent of the polycarbonate copolymer linkages and 50 weight percent of epoxy polymer linkages derived from CY 179, which is similar to the composition of the starting composite material. However, in the unexposed areas, the composition after baking corresponded to approximately 90 weight percent of the polycarbonate copolymer linkages and 10 percent of epoxy polymer linkages derived from CY 179.

While typical embodiments have been set forth for the purpose of illustration, the foregoing description should not be deemed to be a limitation on the scope of the invention. Accordingly, various modifications, adaptations, and alternatives may occur to one skilled in the art without departing from the spirit and scope of the present invention.

1. An optical device structure comprising:
a substrate, said substrate having a composition and a refractive index; and
at least one topological feature disposed on a surface of said substrate comprising a polymeric composite material,
wherein said topological feature has a controlled topological profile, and a controlled refractive index across said topological feature, and wherein said topological feature redirects radiation passing therethrough.

2. The optical device structure of claim 1, wherein said topological feature has a controlled composition.

3. The optical device structure of claim 1, wherein said controlled refractive index across said topological feature is different from said refractive index of said substrate.

4. The optical device structure of claim 1, wherein said controlled refractive index varies across said topological feature.

5. The optical device structure of claim 4, wherein said controlled refractive index varies between a maximum value and a minimum value.

6. The optical device structure of claim 5, wherein said controlled refractive index varies by at least 0.2% across said topological feature.

7. The optical device structure of claim 5, wherein said controlled refractive index has a maximum value at the center of said topological feature.

8. The optical device structure of claim 5, wherein said controlled refractive index has a minimum value at the center of said topological feature.

9. The optical device structure of claim 5, wherein said controlled refractive index varies linearly across said topological feature.

10. The optical device structure of claim 1, wherein said optical device structure is one of a waveguide, a multiplexer, a mirror, and a lens.

11. The optical device structure of claim 1, wherein said substrate is a flexible substrate.

12. The optical device structure of claim 11, wherein said flexible substrate comprises a plastic material.

13. The optical device structure of claim 1, wherein said substrate comprises at least one of a glass, quartz, a ceramic material, a crystalline material, and a semiconductor material.

14. The optical device structure of claim 1, wherein said optical device structure comprises a plurality of said at least one topological feature.

15. The optical device structure of claim 14, wherein said plurality of said at least one topological feature comprises an array.

16. The optical device structure of claim 1, wherein said controlled composition varies across said at least one topological feature.

17. The optical device structure of claim 1, wherein said controlled topological profile comprises at least one of a concave profile, a convex profile, and a polygonal profile.

18. The optical device structure of claim 1, wherein said polymerizable composite comprises a polymeric binder and an uncured monomer.

19. The optical device structure of claim 18, wherein said polymer binder comprises at least one of a cyclic olefin copolymer, an acrylate polymer, a polyimide, a polycarbonate, a polysulfone, a polyphenylene oxide, a polyether ketone, a polyvinyl fluoride, and combinations thereof.

20. The optical device structure of claim 19, wherein said acrylate polymer is at least one of a poly(methyl methacrylate), poly(tetrafluoropropyl methacrylate), poly(2,2,2-triflouroethyl methacrylate), poly(tetrafluoropropyl methacrylate), copolymers comprising structural units derived from an acrylate polymer; and combinations thereof.

21. The optical device structure of claim 18, wherein said uncured monomer is at least one of an acrylic monomer, a cyanate monomer, a vinyl monomer, an epoxide-containing monomer, and combinations thereof.

22. The optical device structure of claim 21, wherein said uncured monomer comprises at least one of benzyl methacrylate, 2,2,2-trifluoroethyl methacrylate, tetrafluoropropyl methacrylate, methyl methacrylate, 3-4-epoxycyclohexylmethyl-3,4-epoxycyclohexane carboxylate, bisphenol A diglycidyl ether, bisphenol F diglycidyl ether, styrene, allyl diglycol carbonate, and cyanate ester.

23. The optical device structure of claim 1, wherein each of said at least one topological feature has a dimension of less than about 100 microns.

24. The optical device structure of claim 1, wherein each of said at least one topological feature has a dimension of less than about 5 microns.

25. The optical device structure of claim 1, wherein each of said at least one topological feature has a dimension of less than about 2 microns.

26. The optical device structure of claim 1, wherein said optical device structure comprises at least one of a multimode waveguide device, a single mode waveguide device, an optical data storage device, a thermo-optic switch, and a microelectronic mechanical system.

27. The optical device structure of claim 1, wherein said substrate comprises a clad layer, said clad layer comprising said optical device structure.

28. A topological feature for use in an optical device structure, wherein said topological feature is disposed on a substrate, said topological feature comprising:
a polymeric composite material having a controlled composition,
wherein said topoplogical feature has a controlled topological profile, and a controlled refractive index across said topological profile, and wherein said topological feature redirects radiation passing therethrough.

29. The topological feature of claim 28, wherein said controlled composition of said topological profile is different from said composition of said substrate.

30. The topological feature of claim 28, wherein said controlled refractive index across said topological profile is different from said refractive index of said substrate.

31. The topological feature of claim 28, wherein said controlled refractive index varies between a maximum value and a minimum value.

32. The topological feature of claim 30, wherein said controlled refractive index varies by at least 0.2% across said topological feature.

33. The topological feature of claim 28, wherein said controlled refractive index has a maximum value at the center of said topological feature.

34. The topological feature of claim 28, wherein said controlled refractive index has a minimum value at the center of said topological feature.

35. The topological feature of claim 28, wherein said controlled refractive index varies linearly across said topological feature.

36. The topological feature of claim 28, wherein said controlled composition varies across said topological feature.

37. The topological feature of claim 28, wherein said topological feature comprises at least one of a concave feature, a convex feature, and a polygonal feature.

38. The topological feature of claim 28, wherein said polymeric composite material is formed from a polymerizable composite material.

39. The topological feature of claim 38, wherein said polymerizable composite material comprises a polymeric binder and an uncured monomer.

40. The topological feature of claim 39, wherein said polymer binder comprises at least one a cyclic olefin copolymer, an acrylate polymer, a polyimide, a polycarbonate, a polysulfone, a polyphenylene oxide, a polyether ketone, a polyvinyl fluoride, and combinations thereof.

41. The topological feature of claim 40, wherein said acrylate polymer is at least one of a poly(methyl methacrylate), poly(tetrafluoropropyl methacrylate), poly(2,2,2-triflouroethyl methacrylate), poly(tetrafluoropropyl methacrylate), copolymers comprising structural units derived from an acrylate polymer; and combinations thereof.

42. The topological feature of claim 39, wherein said uncured monomer is at least one of an acrylic monomer, a cyanate monomer, a vinyl monomer, an epoxide-containing monomer, and combinations thereof.

43. The topological feature of claim 39, wherein said uncured monomer comprises at least one of benzyl methacrylate, 2,2,2-trifluoroethyl methacrylate, tetrafluoropropyl methacrylate, methyl methacrylate, 3-4-epoxycyclohexylmethyl-3,4-epoxycyclohexane carboxylate, bisphenol A diglycidyl ether, bisphenol F diglycidyl ether, styrene, allyl diglycol carbonate, and cyanate ester.

44. The topological feature of claim 28, wherein said topological feature has a dimension of less than about 100 microns.

45. The topological feature of claim 28, wherein said topological feature has a dimension of less than about 5 microns.

46. The topological feature of claim 28, wherein said topological feature has a dimension of less than about 2 microns.

47. The topological feature of claim 28, wherein said optical device structure comprises at least one of a multimode waveguide device, a single mode waveguide device, a thermo-optic switch, a microelectronic mechanical system, and an optical data storage device.

48. The topological feature of claim 28, wherein said substrate comprises a clad layer comprising said optical device structure.

49. An optical device structure comprising:
a substrate; and
at least one topological feature disposed on a surface of said substrate, wherein said topological feature is formed from a polymerizable composite comprising at least one polymer binder and at least one uncured monomer,
wherein said topological feature has a controlled composition profile and a controlled refractive index, said refractive index being different than a refractive index of said substrate; and wherein said topological feature redirects radiation passing therethrough.

50. The optical device structure of claim 49, wherein said polymer binder comprises at least one of a cyclic olefin copolymer, an acrylate polymer, a polyimide, a polycarbonate, a polysulfone, a polyphenylene oxide, a polyether ketone, a polyvinyl fluoride, and combinations thereof.

51. The optical device structure of claim 50, wherein said acrylate polymer is at least one of a poly(methyl methacrylate), poly(tetrafluoropropyl methacrylate), poly(2,2,2-triflouroethyl methacrylate), poly(tetrafluoropropyl methacrylate), copolymers comprising structural units derived from an acrylate polymer; and combinations thereof.

52. The optical device structure of claim 49, wherein said uncured monomer is at least one of an acrylic monomer, a cyanate monomer, a vinyl monomer, an epoxide-containing monomer, and combinations thereof.

53. The optical device structure of claim 49, wherein said uncured monomer comprises at least one of benzyl methacrylate, 2,2,2-trifluoroethyl methacrylate, tetrafluoropropyl methacrylate, methyl methacrylate, 3-4-epoxycyclohexylmethyl-3,4-epoxycyclohexane carboxylate, bisphenol A diglycidyl ether, bisphenol F diglycidyl ether, styrene, allyl diglycol carbonate, and cyanate ester.

54. The optical device structure of claim 49, wherein said controlled composition profile varies across said topological feature.

55. The optical device structure of claim 49, wherein said topological feature comprises at least one of a concave feature, a convex feature, and a polygonal feature.

56. The optical device structure of claim 49, wherein each topological feature has a dimension of less than about 100 microns.

57. The optical device structure of claim 49, wherein each topological feature has a dimension of less than about 5 microns.

58. The optical device structure of claim 49, wherein each topological feature has a dimension of less than about 2 microns.

59. The optical device structure of claim 49, wherein said optical device structure comprises at least one of a multimode waveguide device, a single mode waveguide device, an optical data storage device, a thermo-optic switch, and microelectronic mechanical system.

60. The optical device structure of claim 49, wherein said substrate comprises a clad layer, said clad layer comprising said optical device structure.

61. The optical device structure of claim 1, wherein said substrate comprises at least one of a glass, quartz, a ceramic material, a crystalline material, and a semiconductor material.
